(19) United States
(12) Patent Application Publication
(10) Pub. No.: US 2007/0023368 A1
(43) Pub. Date: Feb. 1, 2007

(54) Treatment surface for battery forming installation

(76) Inventor: Franco Stocchiero, Montorso Vicentino (IT)

Correspondence Address: IP Strategies, Suite I, 12 1/2 Wall Street, Asheville, NC, 28801, US

(21) Appl. No.: 10/571,546

(22) PCT Filed: Sep. 9, 2004
(86) PCT No.: PCT/EP04/52102

§ 371 Date: Mar. 8, 2006

(30) Foreign Application Priority Data
Sep. 11, 2003 (IT) VI2003A000170

(51) Int. Cl. A47F 7/00; B67D 1/16; B67D 5/64

(52) U.S. Cl. 211/49.1; 222/108; 222/173

(57) ABSTRACT

A mobile treatment surface (1) for battery formation comprising: a bearing surface (11) for the batteries; a delivery conduit (3) for the acid to the batteries to be formed; a collecting conduit (4) for the acid outgoing from said batteries to be formed; acid circulation means (9) and means for delivering direct current (50) to the forming batteries. The delivery conduit (3) comprises a first acid adduction pipe (31) coaxially disposed inside a second acid pipe (32) and provided with a plurality of radial holes (311) for taking the acid into the second pipe. The second pipe is provided with a plurality of acid outlet holes (321), each of them being connected to a device (324) for taking the acid into the battery to be formed.

The present invention is about a mobile treatment surface for a vertical developed battery forming installation of the kind described in Patent of Invention no. IT1307517.

According to the aforementioned invention, the accumulator forming installation comprises a plurality of pallets or support elements, in each of which the accumulators to be submitted to the formation treatment are placed.

Each of said pallets comprises current feeding means and electrolyte circulation means for each battery during the formation process.

The formation process takes place in the period in which the pallets are stored in corresponding vertically distributed supports belonging to the forming installation.

Italian Patent application no. VI2003A000099, of the same applicant, describes a method for forming acid lead batteries related to an installation comprising a plurality of pallets disposed spaced and overlapping on a structure with essentially vertical development, where a plurality of batteries is placed.

The method is essentially characterized in that the battery formation takes place with strictly constant parameters of density and temperature of the acid inside the battery during treatment.

This happens both in a stage of first circulation of a lower density acid and in a subsequent stage related to a second circulation of more concentrated acid.

The specific features of the battery formation method of Patent application no. VI2003A000099 tend to warrant a complete treatment homogeneity for each battery, so that the quality of the formed batteries is substantially the same, in order to grant a uniform lifetime of the batteries and to avoid any waste due to a bad formation of the plates present in the batteries.

It has been noted in particular that it is necessary to warrant an equal and constant flow rate of the electrolyte circulating in each cell of each battery, so that the same quantity of acid at the same temperature and density affects the forming plates in each battery.

Only in this way a perfect identity of the batteries can be granted once the treatment is finished.

An important object to be achieved in the operative stage is that the mobile support elements of the batteries under treatment, said batteries being placed at first in a load position and then stored in the forming installation during the treatment period, as well as all the conduits belonging to each of said mobile support elements, grant certain optimal performances. We make reference in particular to the fact that the acid delivery conduits have to grant, for their specific construction, a constant flow rate to each battery cell.

It is furthermore required that, because of the support mobility, the acid collecting conduits do not cause electrolyte losses during the movement of the treatment surface from a load or an unload position to a storage position.

Another object to be achieved is that the handling of the support elements in the forming installation is made easier and that the handling means of said elements are as simple as possible, so that they not increase the constructional complexity of the forming installation.

The above mentioned objects, and other which will be better highlighted in the following description, are attained by a mobile treatment surface for batteries in a battery forming installation where said treatment surface, according to the content of the main claim, comprises:
a mainly longitudinally developed bearing surface, able to receive a plurality of batteries aligned according to said longitudinal direction;
an acid delivery conduit, belonging to said bearing surface, for the delivery to said batteries to be formed;
acid circulation means for each battery;
a collecting conduit for the acid outgoing from said batteries to be formed;
means for delivering direct current,
   and it is characterized in that said delivery conduit, disposed in a substantially horizontal position, has a first internally disposed acid adduction pipe, substantially coaxial with a second acid pipe, said first pipe being provided with a plurality of radial holes for taking said acid into said second pipe, and said second pipe being provided with a plurality of outlet holes for said acid from said delivery conduit, each of said outlet holes being connected to a device for taking the acid into the battery to be formed.

Advantageously, according to the invention, special attention has been paid to manufacturing the first acid delivery conduit, which sends the acid to each battery to be formed on the same treatment surface. In fact, it has been granted that always the same acid flow rate is delivered to each battery, and in particular to each cell of the batteries to be formed.

Another characteristic of the invention is the fact that the collecting conduit for the acid outgoing from the batteries is provided with a check valve, which is normally closed during the movement of the treatment surface in order to avoid any loss of acid during the movement.

A further characteristic is the fact that the collecting conduit for the acid outgoing from the batteries of each treatment surface is vacuum operated by a pump which provides for ensuring the acid circulation in the whole plant.

Further characteristics and features of the invention will be better highlighted in the description of a preferred embodiment of the invention, given in an explanatory but not limiting way, with reference to the figures of the annexed drawings, wherein:

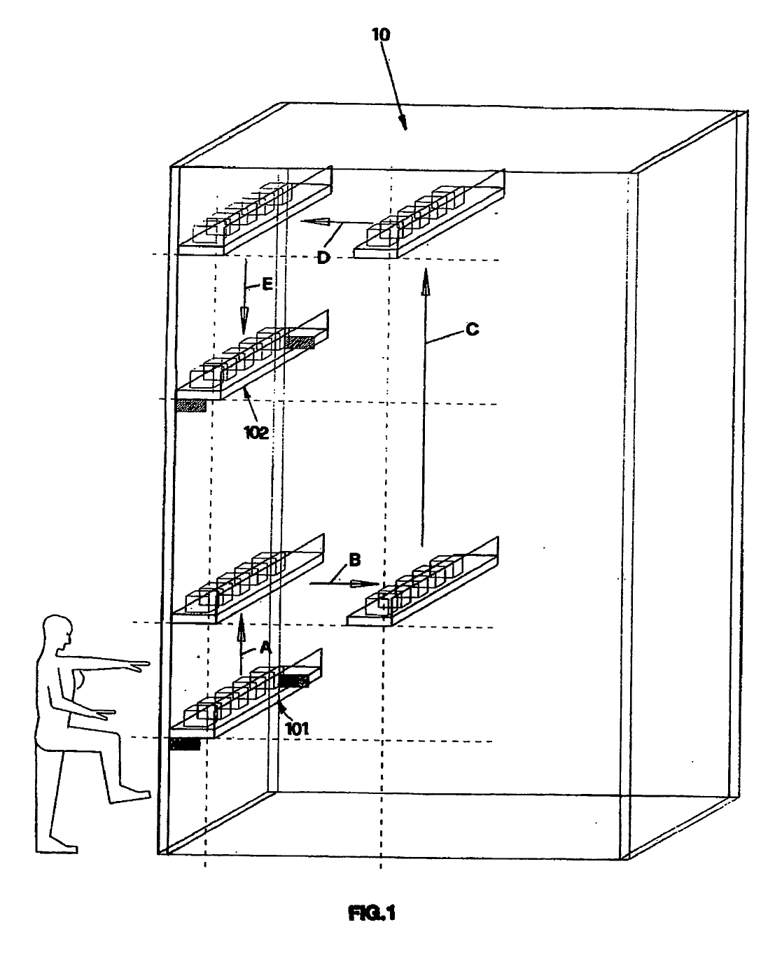

FIG. 1 is a basic scheme of the battery forming installation and in particular of the movement of each mobile treatment surface included in said plant;

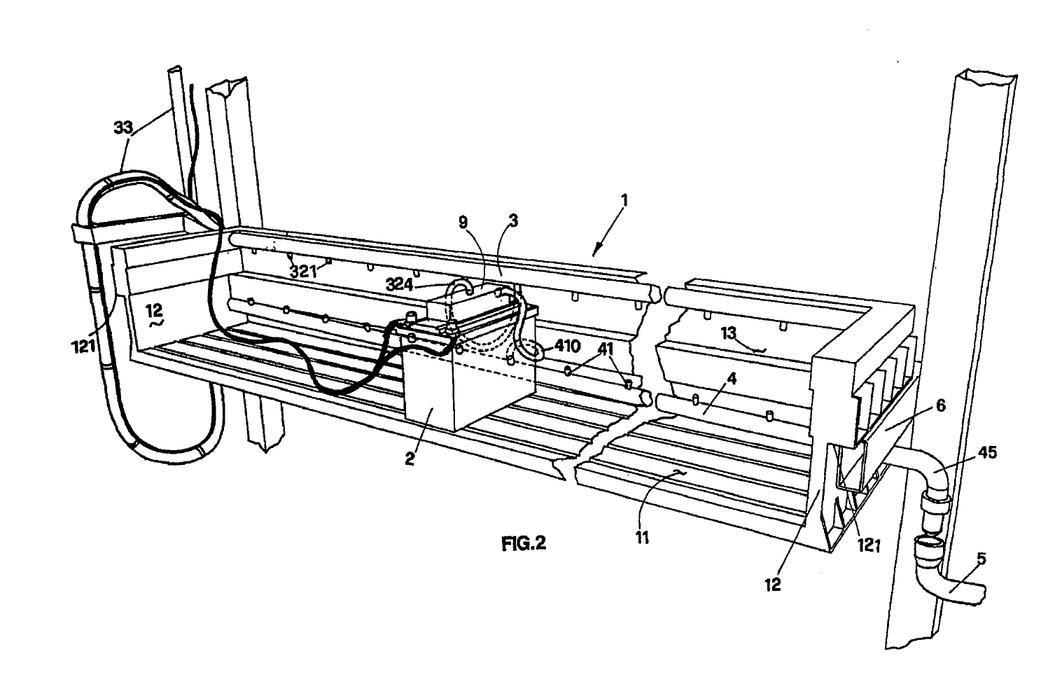

FIG. 2 shows the mobile treatment surface of the invention;

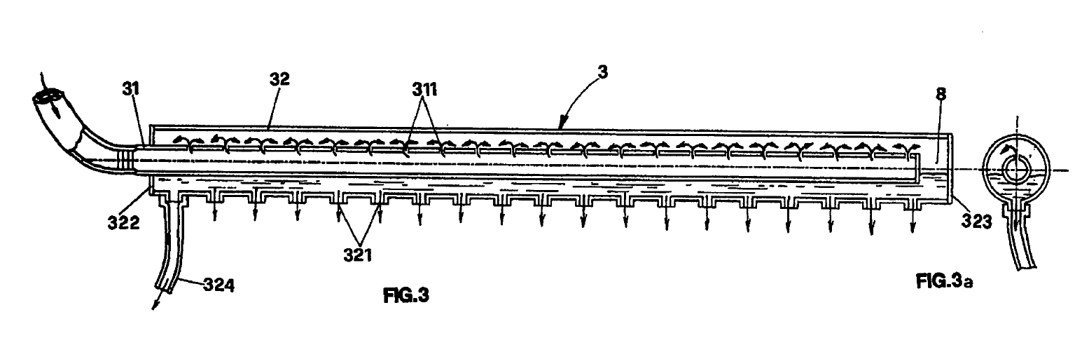

FIG. 3 shows the delivery conduit belonging to the mobile treatment surface of the invention;

FIG. 3a is a sectional view of the conduit of FIG. 3;

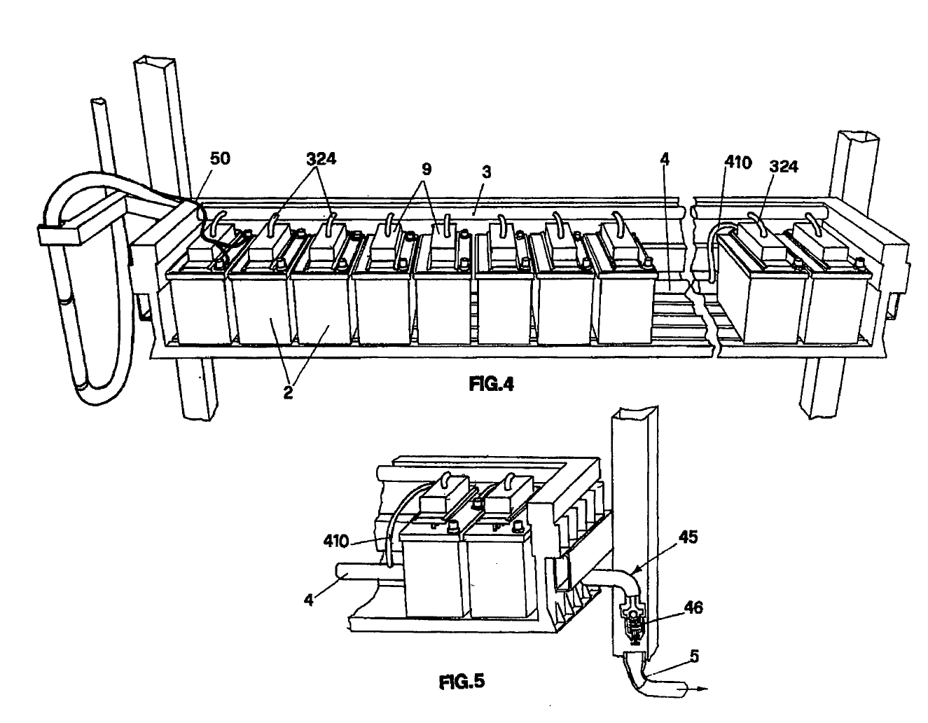

FIG. 4 shows the mobile treatment surface of the invention, with the batteries housed therein for performing the formation treatment; and

FIG. 5 shows a detail of the acid collecting conduit and a connection thereof to the outlet conduit.

With reference to the above mentioned Figures, one can see that in the forming installation scheme of FIG. 1, generally indicated with numeral 10, the mobile treatment surface 1 is in its load position, indicated with numeral 101, where an operator provides for connecting the batteries 2 to the acid delivery and collecting conduits, as well as the current distribution means. Once performed said connections, the treatment surface 1 reaches the placing position, indicated with numeral 102, starting from a load position 101, making at first a vertical rising according to the arrow A, then a horizontal movement according to the arrow B, then a further rising according to the arrow C, a new translation on a horizontal plane according to the arrow D, and at last a lowering according to the arrow E, until the position 102 is reached.

The described operation is an exemplification of one of the possible movements of each mobile treatment surface, which thus passes from a battery load and arrangement position up to a placing position in a forming installation area for all the time required for performing said formation.

The vertically and horizontally directed translation of each mobile treatment plant takes place using known means, like for example pallet transfer elements belonging to the plant or substantially equivalent moving means known in the state of the art.

With reference to FIG. 2, one can see that the mobile treatment surface 1 has a bearing surface 11 on which the batteries 2 will be disposed and subsequently placed, by means of said mobile treatment surface, in their assigned position on the forming installation.

Said mobile treatment surface has two side walls 12, each of them being provided with a overhanging portion 121 which is adapted to lean on shelves, indicated with numeral 6, belonging to the fixed structure of the forming installation.

The mobile treatment surface is completed by an essentially vertical bottom wall 13.

A flexible delivery pipe 33 for the acid, connected to a delivery conduit 3 fixed on the mobile treatment surface 1, reaches each mobile treatment surface 1.

A further collecting conduit for the acid coming from the batteries under treatment is indicated with numeral 4 in FIG. 2.

With reference to the delivery conduit, indicated with numeral 3 and better visible in FIG. 3, one can see that said conduit consists of a first substantially horizontal disposed pipe 31, having a series of holes 311, all of the same diameter and able to eject the pressurized acid in the chamber formed in the space comprised between said first pipe 31 and a second pipe 32, coaxial with the first one and having greater diameter, as shown in FIG. 3.

The second pipe 32 too has outlet holes 321, which are of preferably greater diameter than the holes 311 belonging to the first pipe 31.

Since the pipe 32 has two bottom walls 322 and 323, a collecting chamber for the acid, indicated with numeral 8, is obtained, in which the acid forms a head with respect to the holes 321, and from which the acid exits by gravity and thus with the same pressure at each hole 321.

Through the pipes 324 the acid reaches the battery cells or the batteries to be supplied with the circulating acid.

One can see that the assembly shown in FIG. 3, with the presence of two concentric pipes 31 and 32, together with the formation of a head inside the chamber 8 comprised between the pipe 32 and the internal pipe 31, allows to grant a constant flow rate for each intake hole of the acid to the battery. And this happens for the entire cycle of battery formation. Therefore, by means of the delivery conduit shown in FIG. 3, one of the essential conditions for obtaining a constant quality in the battery formation process, that is to grant a constant flow rate of the circulating acid, is achieved.

In order to optimize the head formation inside the chamber 8 obtained between the coaxial pipes 32 and 31, one can see that the holes 311 belonging to the pipe 31 are disposed radially aligned on the same vertical plane, and with upwardly directed acid outlet, as shown in FIG. 3a, which is a sectional view of FIG. 3, while the outlet holes 321 belonging to the outer pipe 32 are mutually aligned too and disposed on a vertical plane, but they are all oriented downwardly, in order to make easier the electrolyte outflow by gravity.

However, this arrangement of the holes 311 and 321 is not essential, being sufficient that the axes of said holes are not coincident.

Furthermore, with reference to FIG. 4, one can see that the delivery conduit 3 is connected, through delivery pipes 324, to circulation means 9 connected to the upper cap of each battery 2 to be formed.

Circulation means 9 substantially provide for transferring the acid from the delivery conduit 3 to the battery 2.

The acid and the gases dissolved therein outflow from the battery 2 through the tubes 410 connected to the second collecting conduit 4 by means of tubular connections 41, visible in FIG. 2.

The collecting conduit 4, which receives the acid, and the possible gas dissolved therein, circulated inside the batteries 2, is blind on one side and it is provided with an end portion 45 on the opposite side, consisting of a piece of pipe facing downwardly which forms the connection element to the outlet conduit 5 receiving the acid mixed with gas and sending it to the tank of the forming installation.

The outlet conduit 5 does not belong to the mobile treatment surface 1, but it is fixed and a part of the forming installation. The attachment portion of said outlet conduit is funnel-shaped, in order to make easier the connection between the collecting conduit and the outlet conduit.

It is important to point out that the end portion of the collecting conduit 4 comprises a check valve 46, which is preferably of spring type, normally closed when the connection element 45 of the collecting conduit is not inserted in the outlet conduit 5.

Obviously, the valve is opened when the end portion 45 of the collecting conduit 4 is inserted in the outlet conduit 5. This is the condition of the valve in the period in which the battery formation takes place, allowing the continuous circulation of the acid mixed with gas to and from the tank.

The presence of the valve 46 is essential and has a primary importance because, during the movement of the treatment surface, any acid loss in the forming installation is avoided.

Furthermore, a substantially easy movement is granted, also due to the fact that the sole means which are always connected to the treatment surface are the direct current feeding cables 50 and the flexible adduction cable 33 of the electrolyte to the delivery conduit 3.

On the basis of the aforesaid description, it should be understood that the mobile treatment surface 1 for batteries of the invention achieves all the intended objects.

In particular, it is achieved the object to provide for a mobile treatment surface for batteries in which the acid delivery conduits grant a constant flow rate to each battery cell.

It is achieved the object to provide for a mobile treatment surface for batteries in which the collecting conduits of the acid and the gases dissolved therein do not cause electrolyte losses, which could request the battery cleaning once the treatment is finished.

At last, it is achieved the object that the handling of the mobile treatment surfaces in the forming installation is made easier and that the handling means of said surfaces are as simpler as possible, so that they not increase the constructional complexity of the forming installation.

All the described and any other not cited embodiments, if they fall within the scope of protection of the following claims, should be intended as protected by the present patent.

1) A mobile treatment surface for placing, handling and storing batteries in a plant for forming said batteries, said treatment surface comprising:
a mainly longitudinally developed bearing surface, able to receive a plurality of batteries aligned according to said longitudinal direction;
an acid delivery conduit, belonging to said bearing surface, for the delivery to said batteries to be formed;
acid circulation means for each battery;
a collecting conduit for the acid belonging to said bearing surface and outgoing from said batteries to be formed;
means for delivering direct current,
wherein said delivery conduit, disposed in a substantially horizontal position, has a first internally disposed acid adduction pipe, substantially coaxial with a second acid pipe, said first pipe being provided with a plurality of radial holes for taking said acid into said second pipe, and said second pipe being provided with a plurality of outlet holes for said acid from said delivery conduit, each of said outlet holes being connected to a device for taking the acid into the battery to be formed.

2) The mobile treatment surface according to claim 1, wherein said radial holes have lesser diameter than said outlet holes.

3) The mobile treatment surface according to claim 1, wherein said radial holes belonging to said first pipe and said outlet holes belonging to said second pipe have not coincident axes.

4) The mobile treatment surface according to claim 1, wherein an acid head is present in said second pipe, in order to grant the same flow rate of said acid in each outlet hole.

5) The mobile treatment surface according to claim 1, wherein said collecting conduit is disposed in a substantially horizontal position and comprises a plurality of tubular connections, an acid outlet pipe from each battery to said collecting conduit being connected to each of them, said collecting conduit having a blind bottom plate on one side and a connection element to an outlet conduit of the acid, fixed to the structure of said forming installation, on the other side.

6) The mobile treatment surface according to claim 5, wherein said connection element to said outlet conduit comprises an acid check valve, closed during the handling of said support element from the load/unload position to the stop forming position, or vice-versa.

7) The mobile treatment surface according to claim 5, wherein said collecting conduit is vacuum operated by said outlet conduit by means of said connection element.

8) The mobile treatment surface according to claim 1, wherein said bearing surface is delimited by two walls, disposed at the side ends, and by an essentially vertical bottom wall connecting said side walls, said side walls being provided with bearing surfaces on shelves belonging to the structure of said plant.

9) The mobile treatment surface according to claim 8, wherein each of the walls of said bearing surface is provided with a overhanging portion which is adapted to lean on a corresponding shelf belonging to said forming installation.
